(19) United States
(12) Patent Application Publication
(10) Pub. No.: US 2015/0002548 A1
(43) Pub. Date: Jan. 1, 2015

(54) INFORMATION PROCESSING APPARATUS, AND DISPLAY CONTROL METHOD

(71) Applicant: KABUSHIKI KAISHA TOSHIBA, Tokyo (JP)

(72) Inventor: Hideyuki TSUTSUMITAKE, Kanagawa (JP)

(73) Assignee: KABUSHIKI KAISHA TOSHIBA, Tokyo (JP)

(21) Appl. No.: 14/153,537

(22) Filed: Jan. 13, 2014

(30) Foreign Application Priority Data
Jun. 28, 2013 (JP) 2013-137352

(51) Int. Cl. G09G 5/14; G06T 3/40; G06F 3/0485

(52) U.S. Cl. CPC G09G 5/14; G06F 3/0485; G06T 3/40
USPC 345/635

(57) ABSTRACT

An information processing apparatus includes a reception module configured to receive image data from external devices (e.g., smart phones, tablets, laptop computers, etc.). The image data includes images from each external device that correspond to images displayed on the external device. The information processing apparatus also includes a display control module configured to select an arrangement pattern comprising a plurality of display regions to display the images shared from the external devices. The arrangement pattern is selected from a plurality of arrangement patterns according to the number of images to be displayed on the display screen and information about the aspect ratio of each image to be displayed. The display control module is further configured to display the image data on a display screen according to the selected arrangement pattern.

### CROSS-REFERENCE TO RELATED APPLICATION

This application is based upon and claims the benefit of priority from Japanese Patent Application No. 2013-137352, filed Jun. 28, 2013, the entire contents of which are incorporated herein by reference.

### FIELD

Embodiments described herein relate generally to an information processing apparatus and a display control method.

### BACKGROUND

A mirroring function, such as Miracast™, is known which shows information displayed on several different smart phones at the same time on a single large display screen in order to share the information displayed on each of the smart phones.

However, in the related art, when information from the various smart phones is displayed on the large display screen at the same time, it is difficult, for example, to adjust the display position of the information from the various smart phones, on the large display screen.

### DESCRIPTION OF THE DRAWINGS

FIG. 1 is a block diagram depicting a display control system according to a first embodiment.

FIG. 2 is a view illustrating a first example of arrangement patterns stored in an information processing apparatus according to the first embodiment.

FIG. 3 is a view illustrating a second example of the arrangement patterns stored in the information processing apparatus according to the first embodiment.

FIG. 4 is a view illustrating a third example of the arrangement patterns which are stored in the information processing apparatus according to the first embodiment.

FIG. 5 is a flowchart illustrating a process for displaying a plurality of available images on the information processing apparatus according to the first embodiment.

FIGS. 6A and 6B depict a process for extracting an available image by the information processing apparatus according to the first embodiment.

FIG. 7 is a flowchart illustrating a process for moving the position of the available image in the information processing apparatus according to the first embodiment.

FIG. 8 is a view illustrating the process for moving the position of the available image in the information processing apparatus according to the first embodiment.

FIG. 9 is a block diagram depicting the configuration of a display control system according to a second embodiment.

FIG. 10 is a view illustrating an example in which an arrangement pattern is reselected in the information processing apparatus according to the second embodiment.

FIG. 11 is a block diagram depicting the configuration of a display control system according to a third embodiment.

FIG. 12 is a flowchart illustrating a process to select an arrangement pattern depending on a change in the orientation of a display screen in an information processing apparatus according to the third embodiment.

FIG. 13 is a view illustrating the process to select the arrangement pattern depending on the change in the shape of the display screen in the information processing apparatus according to the third embodiment.

FIG. 14 is a block diagram depicting the configuration of a display control system according to a fourth embodiment.

FIG. 15 is a flowchart illustrating a process for non-display of a sharing image depending on an addition process in an information processing apparatus according to the fourth embodiment.

FIG. 16 is a view illustrating the process for non-display of the sharing image depending on the addition process in the information processing apparatus according to the fourth embodiment.

FIGS. 17A and 17B are views illustrating a process to display a plurality of available images on a display screen by overlapping parts of the plurality of available images depending on the addition process in an information processing apparatus according to a first modification example.

FIG. 18 is a view illustrating a process for displaying a single available image from a plurality of available images on a full screen in an information processing apparatus according to a second modification example.

### DETAILED DESCRIPTION

Embodiments provide an information processing apparatus and a display control method for improving convenience when information which is displayed on a plurality of external devices, is displayed on a single display at the same time.

In general, according to one embodiment, an information processing apparatus includes a reception module configured to receive image data (e.g., streamed video data, still pictures, screen captures, etc.) from one or more external devices (e.g., smart phones, tablets, desktop computers, laptop computers, etc.). The image data includes a plurality of shared images that each correspond, respectively, to an image displayed an external device. The information processing apparatus also includes a display control module configured to select an arrangement pattern (e.g., a first arrangement pattern) that includes different display regions in which each of the shared images can be, respectively, displayed. The arrangement pattern is selected from a plurality of arrangement patterns according to the number of shared images to be displayed on the display screen and information that indicates an aspect ratio (picture width (horizontal distance) vs. picture height (vertical distance)) for each shared image. In some embodiments, various potential arrangement patterns may be predetermined and stored for later selection. The display control module is also configured to display the image data on the display screen according to the selected arrangement pattern.

Hereinafter, a display control system according to an embodiment will be described with reference to the accompanying drawings.

### First Embodiment

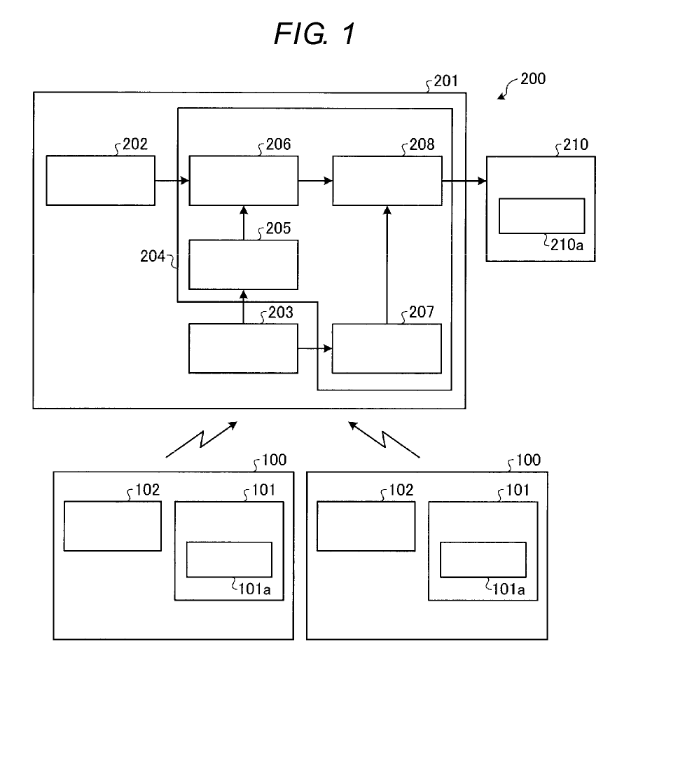

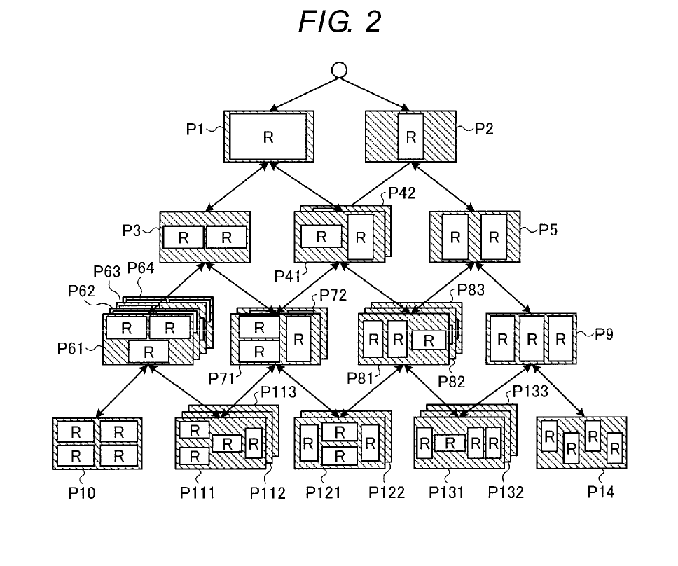

FIG. 1 is a block diagram illustrating the configuration of a display control system according to a first embodiment. FIGS. 2 to 4 are views illustrating examples of arrangement patterns which are stored in an information processing apparatus according to a first embodiment.

As shown in FIG. 1, a display control system according to the first embodiment includes a plurality of mobile terminal apparatuses 100 (examples of external devices), such as a smart phone, a tablet terminal, or a notebook personal computer (PC), and an information processing apparatus 200, such as a digital sign, a display screen, or a digital television. The mobile terminal apparatuses 100 are connected to the information processing apparatus 200 via a network such as, for example, a wireless local area network (WLAN).

In the display control system, when various information which is displayed on the mobile terminal apparatuses 100 are shared with the information processing apparatus 200 using a display transmission technology, such as Miracast™ as an example, the various information displayed on a display screen 101a (an example of a first display screen) of a display unit 101 included in the mobile terminal apparatus 100 is transmitted to the information processing apparatus 200. It is thus possible to display information shown on display screen 101a on a display screen 210a (an example of a second display screen) of an image display unit 210 included in the information processing apparatus 200.

The mobile terminal apparatus 100 includes the display unit 101 and an image transmission unit 102. The display unit 101 includes the display screen 101a which comprises a liquid crystal display (LCD), an organic electro luminescence (EL) display, or the like.

The display screen 101a may show various types of information, including what may be called a terminal image (an example of a first image) which includes a moving picture (video) that is to be displayed under the control of a control unit which is not depicted in the drawing.

When the image transmission unit 102 is instructed to share a terminal image (which is displayed on the display screen 101a) with the information processing apparatus 200 the image transmission unit 102 uses display transmission technology to transmit a sharing image (an example of a second image) to the information processing apparatus 200. The sharing image may include an available image corresponding to the terminal image. For example, when the terminal image is a moving picture, the image transmission unit 102 transmits a moving picture data stream (streaming video data) to the information processing apparatus 200 as image data. In this example, the available image corresponds to a version of the terminal image that can be displayed on the display screen 210a.

In the first embodiment, the image transmission unit 102 receives device information such as the resolution of the display screen 210a, before the image transmission unit 102 transmits the image data to the information processing apparatus 200. Upon receipt of the device information, the image transmission unit 102 generates a sharing image, which includes the available image. The available image is acquired through a conversion performed on terminal image such that, for example, the resolution of the available image is based on the received device information (for example, display resolution of display screen 210a). The image transmission unit 102 then transmits the generated sharing image to the information processing apparatus 200.

The information processing apparatus 200 includes a control unit 201 and the image display unit 210. The image display unit 210 includes the display screen 210a which is, for example, an LCD screen or the like. The display screen 210a can display various types of information, such as, for example, the sharing image received from a mobile terminal apparatus 100.

The various types of information are displayed under the control of the control unit 201.

In addition, the display screen 210a can be changeable or adjustable to have, for example, a vertically long orientation (narrow aspect ratio display) or a horizontally long orientation (wide aspect ratio display). A vertically long orientation may also be referred to as a “portrait” display orientation, and a horizontally long orientation may also be referred to as a “landscape” display orientation.

The control unit 201 controls the information processing apparatus 200. In the embodiment, the control unit 201 includes an arrangement pattern storage unit 202, an image receiving unit 203, and a display control unit 204. When the terminal image is shared using the display transmission technology, the image receiving unit 203 receives the image data (e.g., a sharing image) from the mobile terminal apparatus 100. The image data is transmitted by transmission unit 102.

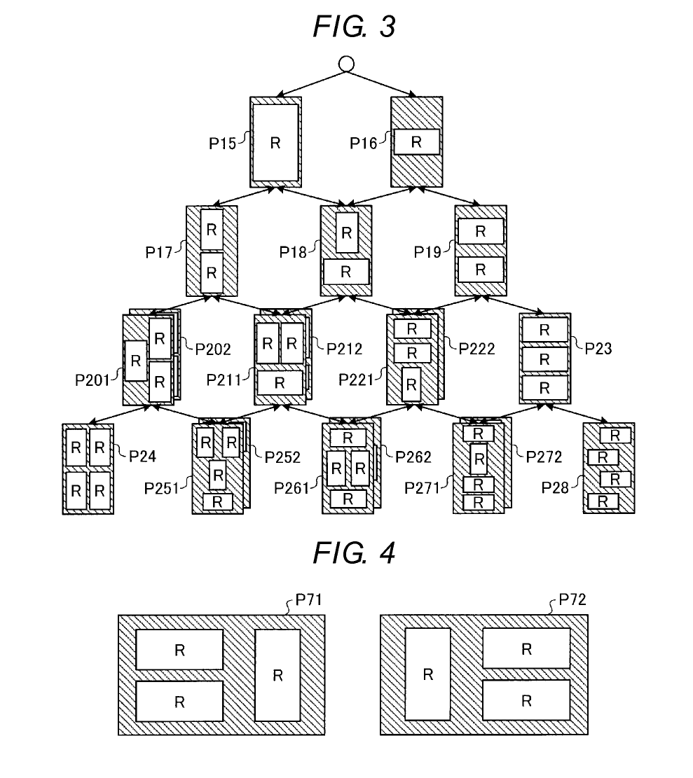

The arrangement pattern storage unit 202 stores various possible arrangement patterns of display regions on the display screen 210a. In each display region an image transmitted from a mobile terminal 100 can be displayed. Thus, in general, the number of display regions arranged on the display screen 210a corresponds to the number of shared images that are transmitted to the information processing apparatus 200, though there may be an upper limit on the number of shared images that can be displayed at any one time. In the embodiment, when the number shared images is equal to or less than a predetermined upper limit (for example, four), the arrangement pattern storage unit 202 stores arrangement patterns of display regions R, which respectively correspond to the number of sharing images received by the image receiving unit 203, as shown in FIGS. 2 and 3.

In the embodiment, the arrangement pattern storage unit 202 stores several different arrangement patterns, for example, as depicted in FIG. 2, arrangement patterns P1, P2, P3, P41 and P42, P5, P61 to P64, P71 and P72, P81 to P83, P9, P10, P111 to P113, P121 and P122, P131 to P133, and P14 are available when the display screen 210a is to a horizontally long configuration (wide aspect ratio). When the display screen 210a is in a vertically long configuration (narrow aspect ratio) other arrangement patterns are also available. For example, as depicted in FIG. 3, arrangement pattern storage unit 202 may store, for example, arrangement patterns P15, P16, P17, P18, P19, P201 and 202, P211 and P212, P221 and P222, P23, P24, P251 and P252, P261 and P262, P271 and P272, and P28.

As an example, the arrangement patterns P71 and P72 are arrangement patterns which can be selected when the number of sharing images to be displayed on the display screen 210a is three, the available images for two sharing images of the three sharing images are horizontally long images, and an available image fora remaining sharing image is a vertically long image.

More specifically, the arrangement pattern P71 has two display regions R corresponding to two horizontally long available images that are arranged in the vertical direction (with respect to each other) on the left side of the display screen 210a, and a single display region R corresponding to a single vertically long available image is arranged on the right side of the display screen 210a, as shown in FIG. 4.

The arrangement pattern P72 is an arrangement pattern in which a single display region R corresponding to the single vertically long available image is arranged on the left side of the display screen 210a and two display regions R corresponding to the two horizontally long available images are arranged in the vertical direction (with respect to each other) on the right side of the display screen 210a.

The display control unit 204 controls the display of the various types of information on the display screen 210a of the image display unit 210. In addition, when the display control unit 204 receives the image data from the mobile terminal apparatus 100 using the display transmission technology, the display control unit 204 displays the sharing images on the display screen 210a based on the received image data.

In addition, when the display control unit 204 receives the image data from a plurality of mobile terminal apparatuses 100, the display control unit 204 selects an arrangement pattern from the arrangement pattern storage unit 202 based on the number of images received from the plurality of mobile terminal apparatuses 100 and information which indicates whether the sharing images are vertically long images or horizontally long images. The display control unit 204 displays each of the plurality of sharing images on the display screen 210a according to the selected arrangement pattern. In this embodiment, it is assumed that the plurality of sharing images displayed on the display screen 210a are arranged on a virtual plane which includes the display screen 210a (that is, displayed images on display screen 210a are not stacked on each other or displayed with portions overlapping each other).

Here, the display control unit 204 includes an image analysis unit 205 that acquires aspect information which indicates, based on the received image data, the aspect ratio of the sharing image. The image analysis unit 205 detects whether the shared images have a wide or narrow aspect ratio.

The display control unit 204 also includes a display region management unit 206 that selects an arrangement pattern from the arrangement pattern storage unit 202, an image scaler 207 that changes an image size such that the available image included in the sharing image is fit to the display screen 210a, and an image composition unit 208 that displays the available image at the image size set by the image scaler 207 according to the arrangement pattern selected by the display region management unit 206, on the display screen 210a.

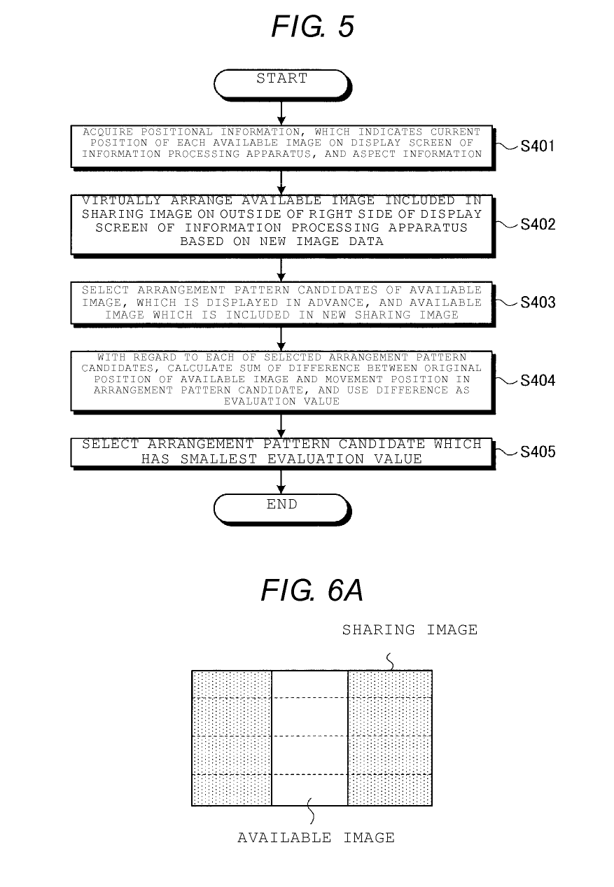

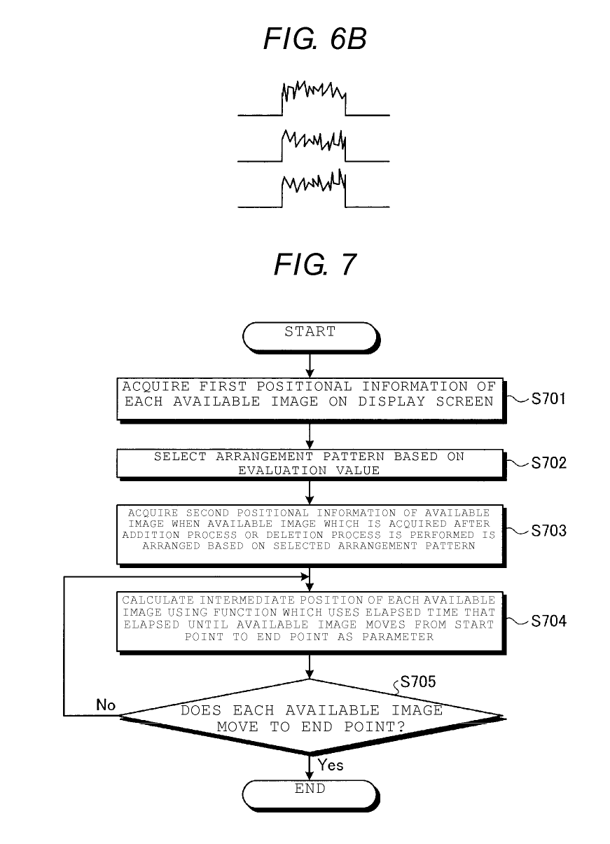

A process for displaying shared imagines on the information processing apparatus 200 according to the embodiment will be described with reference to FIGS. 5 to 6B.

FIG. 5 is a flowchart depicting the flow of a process to display a plurality of images according to the first embodiment.

FIGS. 6A and 6B are views illustrating a process to extract an available image according to the first embodiment.

If a mobile terminal apparatus 100 requests sharing information displayed on the display screen 101a from the image receiving unit 203, the image receiving unit 203 starts to receive image data from the mobile terminal apparatus 100. In this embodiment, the image receiving unit 203 receives moving picture data (video data) from the mobile terminal apparatus 100.

If the mobile terminal apparatus 100 requests ending of the sharing of information displayed on the display screen 101a from the image receiving unit 203, the image receiving unit 203 ends the receiving of the image data from the mobile terminal apparatus 100.

When the image receiving unit 203 starts to receive new image data, the image analysis unit 205 analyzes the new image data. Specifically, as shown in FIG. 6A, the image analysis unit 205 scans the sharing image in the horizontal direction. The image analysis unit 205 then extracts an available image from the sharing image based on the scanning results acquired (refer to FIG. 6B). The image analysis unit 205 acquires aspect information which indicates the aspect ratio of the available image, and thereby determines whether the available image is a vertically long image or a horizontally long image based on the acquired aspect information.

The display region management unit 206 acquires positional information indicating the position on the display screen 210a for each available image to be displayed on the display screen 210a and aspect information indicating the aspect ratio of each available image (step S401). The display region management unit 206 determines whether each available image to be displayed is a vertically long image or a horizontally long image according to the acquired aspect information.

When the image receiving unit 203 receives new image data, the display region management unit 206 virtually arranges the available images to be displayed on the virtual plane including the display screen 210a (step S402).

Therefore, the display region management unit 206 performs a process to add the new sharing image on the display screen 210a. On the other hand, when it is requested that the sharing of the various types of information displayed on the display screen 101a of the mobile terminal apparatus 100 be ended, the display region management unit 206 ends the display of the available image included in the sharing image on the display screen 210a based on the image data received from the mobile terminal apparatus 100. Therefore, the display region management unit 206 executes a process to delete the sharing image from the display screen 210a.

When the display region management unit 206 performs the process to add a new sharing image, the display region management unit 206 selects the arrangement pattern candidates for the available images (including the new image) based on the positional information and the aspect information acquired from the arrangement pattern storage unit 202 (step S403).

When the display region management unit 206 executes the process to delete the sharing image, the display region management unit 206 selects an arrangement pattern candidate of the available images (no longer including the deleted image) based on the positional information and the aspect information acquired from the arrangement pattern storage unit 202.

In this embodiment, the display region management unit 206 specifies the number of images of the available images which are displayed on the display screen 210a after the addition process or the deletion process is performed based on the acquired positional information and the number of sharing images on which the addition process or the deletion process is performed. That is, the display region management unit 206 specifies the number of images of the plurality of sharing images based on the image data received from each of the plurality of mobile terminal apparatuses 100.

Subsequently, the display region management unit 206 selects an arrangement pattern candidate from the arrangement pattern storage unit 202 based on the specified number of images, information which indicates whether each of the available images to be displayed on the display screen 210a is a vertically long image or a horizontally long image, and the change in the display screen 210a (that is, orientation information which indicates whether the display screen 210a currently has a vertically long orientation or a horizontally long orientation).

Here, an example of an arrangement pattern selection method used when the display screen 210a is changed to a horizontally long orientation will be described. Here, although the arrangement pattern selection method used when the display screen 210a is changed to a horizontally long orientation will be described, it is assumed that arrangement pattern selection is performed in a similar manner when the display screen 210a is changed to a vertically long orientation.

When a single horizontally long available image is to be displayed on the display screen 210a according to the arrangement pattern P1, the specified number of images is “2”, and an available image included in the sharing image on which the addition process is performed is a vertically long image, the display region management unit 206 selects the arrangement patterns P41 and P42 which each include both a horizontally long-shaped display region R and a vertically long-shaped display region R as arrangement pattern candidates from the plurality of arrangement patterns shown in FIG. 2.

In addition, when two available images are to be displayed on the display screen 210a according to the arrangement pattern P41, the specified number of images is “3”, and an available image included in the sharing image on which the addition process is performed is a horizontally long image, the display region management unit 206 selects the arrangement patterns P71 and P72 which each include two horizontally long-shaped display regions R and a single vertically long-shaped display region R as the arrangement pattern candidates from the plurality of arrangement patterns shown in FIG. 2.

In addition, when three available images are to be displayed according to the arrangement pattern P71, the specified number of images is “4”, and an available image included in the sharing image on which the addition process is performed is a horizontally long image, the display region management unit 206 selects the arrangement patterns P111 to P113 which each include three horizontally long-shaped display regions R and a single vertically long-shaped display region R as the arrangement pattern candidates from the plurality of arrangement patterns shown in FIG. 2.

Returning to FIG. 5, with regard to each of the selected arrangement pattern candidates, the display region management unit 206 calculates the sum of the movement amounts (differences) between the original position of each of the available images which are displayed on the display screen 210a before the addition process or the deletion process is performed (for example, the central coordinates of each of the available images) and a position (moved position) which corresponds to the position of each of the arrangement pattern candidates on the virtual plane which includes the display screen 210a. Further, the display region management unit 206 uses the calculated sum as the evaluation value of each of the arrangement pattern candidates (step S404).

The display region management unit 206 then selects an arrangement pattern candidate that has the smallest overall arrangement pattern candidate evaluation value (in other words, an arrangement pattern candidate which provides the smallest total movement amount for the available images displayed on the display screen 210a before the addition process or the deletion process is performed) (step S405).

For example, when the addition process is performed in a state in which two available images are already displayed on the display screen 210a according to the arrangement pattern P41 and thus the arrangement patterns P71 and P72 are selected as the arrangement pattern candidates (refer to FIGS. 2 and 4), the display region management unit 206 selects the arrangement pattern P71, in which available images that are horizontally long images arranged on the left side toward the display screen 210a before the addition process is performed are moved in the upper direction or in the lower direction, as the arrangement pattern which includes the smallest movement amount between the arrangement patterns P71 and P72.

In the embodiment, although the display region management unit 206 uses the movement amount of the available image displayed on the display screen 210a before the addition processor the deletion process is performed as the evaluation value, the exemplary embodiment is not limited thereto. For example, the display region management unit 206 may calculate an evaluation value for each of the selected arrangement pattern candidates based on the degree of importance of each of the available images displayed on the display screen 210a before the addition process or the deletion process is performed.

In detail, the display region management unit 206 increases the evaluation value of an arrangement pattern candidate in which an available image including a low degree of importance is arranged on the left side toward the display screen 210a between the available images displayed on the display screen 210a before the addition process or the deletion process is performed. Here, the degree of importance is determined based on, for example, the update frequency of an available image included in a sharing image based on the image data received by the image receiving unit 203, and increases in accordance with the update frequency increasing. Further, the display region management unit 206 selects the arrangement pattern candidate including the smallest evaluation value as the arrangement pattern among the respective selected arrangement pattern candidates, and thus it is possible to move an available image including a low degree of importance to the left side toward the display screen 210a.

In addition, in the embodiment, although the display region management unit 206 selects the arrangement pattern candidate including the smallest evaluation value as the arrangement pattern, an arrangement pattern may be selected in which the movement amount of available images is equal to or less than a predetermined value. For example, the display region management unit 206 may select an arrangement pattern, in which the movement amount of an available image displayed on the display screen 210a before the addition process is performed is the second smallest, among the respective selected arrangement pattern candidates when the evaluation value is equal to or less than the predetermined value.

The image composition unit 208 displays the plurality of available images acquired after the addition process or the deletion process according to the selected arrangement pattern. Therefore, the image composition unit 208 displays the available images, included in each of the plurality of sharing images based on the plurality of image data received from the plurality of mobile terminal apparatuses 100, on the display screen 210a according to the selected arrangement pattern.

In the embodiment, when an available image included in each of the plurality of sharing images is displayed on the display screen 210a according to the selected arrangement pattern, the image scaler 207 changes the image size of the available image such that the available image has the largest image size which fits in the display screen 210a while the aspect ratio of the available image included in each of the plurality of sharing images is maintained.

Further, the image scaler 207 outputs each of the available images at the changed image sizes to the image composition unit 208. The image composition unit 208 displays the plurality of available images at the changed image sizes on the display screen 210a according to the selected arrangement pattern.

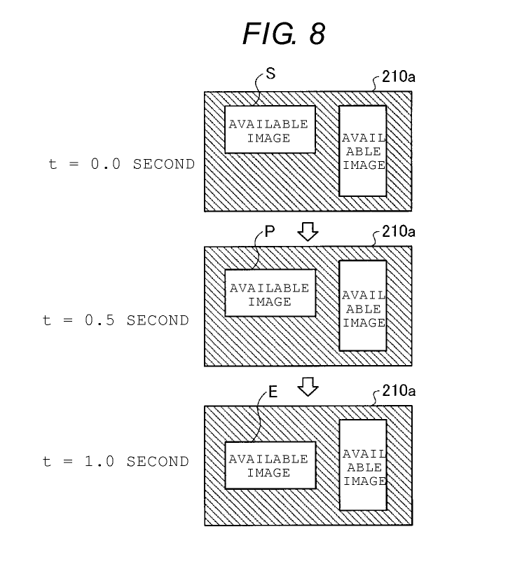

A process to move the position of an available image on the display screen 210a (or a virtual plane including the display screen 210a) according to the selected arrangement pattern will be described with reference to FIGS. 7 and 8. FIG. 7 is a flowchart depicting the flow of the process to move the position of the available image in the information processing apparatus according to the first embodiment. FIG. 8 is a view illustrating the process to move the position of the available image in the information processing apparatus according to the first embodiment.

When the evaluation value of each of the arrangement pattern candidates is calculated in step S404 of FIG. 5, the display region management unit 206 acquires first positional information which indicates the position of each available image (hereinafter, referred to as a start point S) to be displayed on the display screen 210a (virtual plane) before the addition process or the deletion process is performed (step S701).

Subsequently, the display region management unit 206 selects an arrangement pattern from among the arrangement pattern candidates based on the calculated evaluation values (step S702). Further, when a plurality of available images is displayed on the display screen 210a according to the selected arrangement pattern, the display region management unit 206 acquires second positional information which indicates the position (hereinafter, referred to as an end point E) of each of the available images on the display screen 210a (virtual plane) (step S703).

The image composition unit 208 calculates an intermediate position P through which the available image is to pass in the process in which the available image moves from the start point S to the end point E using a function (refer to Equation 1 below) in which an elapsed time t (corresponding to the time to move an image from start point S to end point E), is used as a parameter (step S704). In this embodiment, it is assumed that the elapsed time t is a value between approximately 0 to 1 second. The image composition unit 208 calculates the intermediate position P for each of the available images displayed on the display screen 210a before the addition process or the deletion process is performed.

P=S×(1−t)+E×t (1)

The image composition unit 208 repeats the process shown in step S704 until the available image is moved to the end point E (No in step S705). Therefore, it is possible for the image composition unit 208 to perform display such that the available image successively moves when the position of the available image on the display screen 210a is moved according to the selected arrangement pattern.

For example, when the process to delete the available image (e.g., the available image on the lower left toward the display screen 210a) displayed on the display screen 210a is performed according to the arrangement pattern P71 and the arrangement pattern P41 is selected as the next arrangement pattern to be used, the image composition unit 208 calculates the intermediate position P of the upper left available image at intervals of every predetermined time increment (for example, 0.5 seconds). The image composition unit 208 successively moves the available image by moving the upper left available image to the calculated intermediate position P whenever a new intermediate position P is calculated, as shown in FIG. 8.

As described above, according to the first embodiment, when available images corresponding to a plurality of terminal images are displayed on the display screen 210a at the same time, it is not necessary for a user to manually adjust the display positions of the available images. Therefore, it is possible to improve convenience when the available images corresponding to the plurality of terminal images displayed on the plurality of mobile terminal apparatuses 100 are displayed on the information processing apparatus 200.

In addition, the display region management unit 206 may perform a reduction and/or movement in the peripheral direction of the display screen 210a on a sharing image which is obtained by performing less operation input in the mobile terminal apparatus 100 between the plurality of sharing images displayed on the display screen 210a. The display region management unit 206 may, for example, reduce the size of and move a sharing image to an edge of display screen 210a when it is detected the sharing image has been infrequently updated or potentially inactive.

### Second Embodiment

A second embodiment provides an example in which an arrangement pattern is reselected when a conversion is performed such that an available image displayed on the display screen is changed from a horizontally long image to a vertically long image or converted from a vertically long image to a horizontally long image. In the description below, details which overlap the first embodiment will not necessarily be repeated.

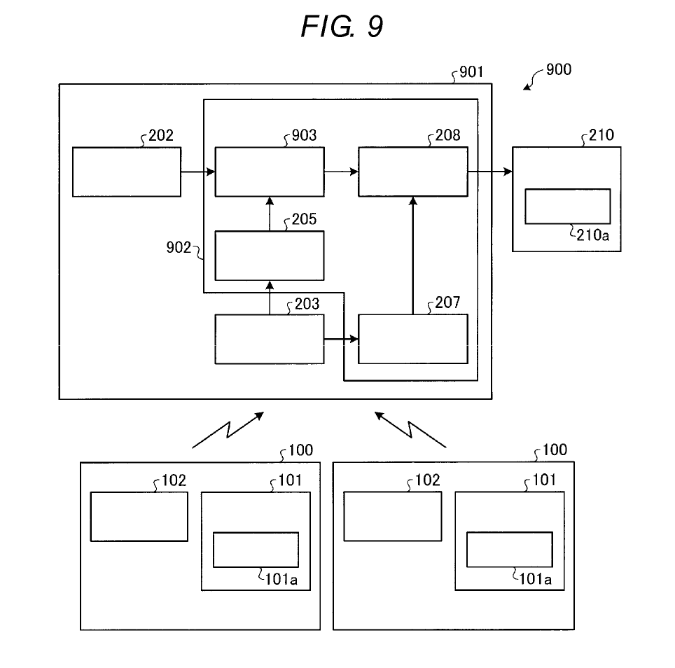

FIG. 9 is a block diagram illustrating the configuration of a display control system according to the second embodiment.

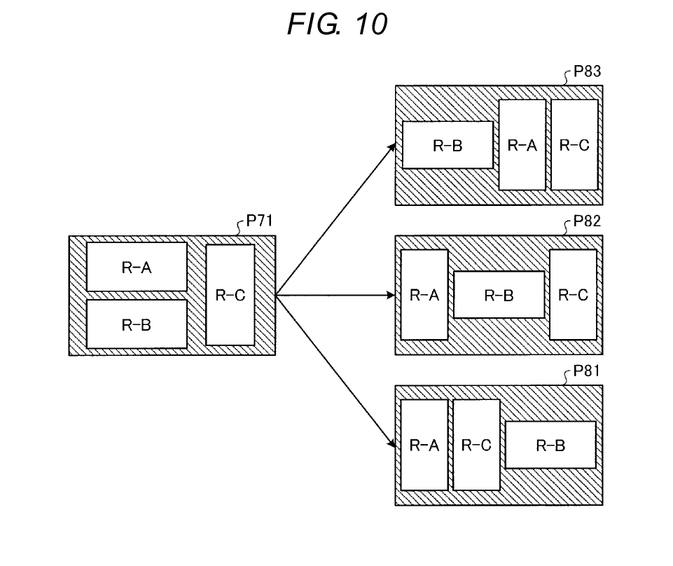

FIG. 10 is a view illustrating an example in which an arrangement pattern is reselected in the information processing apparatus according to the second embodiment. As depicted, a control unit 901 of an information processing apparatus 900 includes arrangement pattern storage unit 202, image receiving unit 203, and display control unit 902. The display control unit 902 reselects an arrangement pattern when an available image displayed on the display screen 210a is converted from a horizontally long image to a vertically long image or from a vertically long image to a horizontally long image.

Here, when the available images are displayed on the display screen 210a based on received image data and the image analysis unit 205 determines that at least one of the available images is converted from a horizontally long image to a vertically long image or from a vertically long image to a horizontally long image, a display region management unit 903 reselects arrangement pattern candidates from the arrangement pattern storage unit 202 based on the number of available images and information that indicates whether an available image has changed to a vertically long image or a horizontally long image.

The display region management unit 903 calculates the sum of the movement amount between the original position of each of the available images displayed on the display screen 210a and the moved position of the available images for each of the arrangement pattern candidates. The display region management unit 903 uses the calculated sum as the evaluation value for each of the arrangement pattern candidates. The display region management unit 903 selects an arrangement pattern candidate having the smallest arrangement pattern candidate evaluation value (in other words, an arrangement pattern candidate providing the overall smallest movement amount of the available images).

For example, as shown in FIG. 10, when available images are displayed on the display screen 210a according to the arrangement pattern P71, which includes two horizontally long display regions R-A and R-B and a single vertically long display region R-C, and an available image corresponding to the image displayed in display region R-A is converted from a horizontally long image to a vertically long image, the display region management unit 903 selects three arrangement patterns P81 to P83 as the arrangement pattern candidates from the arrangement pattern storage unit 202. The display region management unit 903 then selects arrangement pattern P82 which has the smallest evaluation value (in other words, the arrangement pattern P82 requires the smallest movement amount of the available images displayed on the display screen 210a) from among the three arrangement patterns P81 to P83. Therefore, when an arrangement pattern is selected because an available image displayed on the display screen 210a is converted from a horizontally long image to a vertically long image or from a vertically long image to a horizontally long image, it is possible to understand the correspondence between an available image acquired before the new arrangement pattern is selected and an available image acquired after the arrangement pattern is initially selected.

As described above, according to the information processing apparatus 900, when an available image which is displayed on the display screen 210a is converted from a horizontally long image to a vertically long image or from a vertically long image to a horizontally long image, it is not necessary for a user to adjust the display position of the available image, and thus it is possible to improve convenience when an available image displayed on the display screen 210a is converted from a horizontally long image to a vertically long image or from a vertically long image to a horizontally long image.

### Third Embodiment

A third embodiment is an example in which an arrangement pattern is selected depending on changes in the display screen of an information processing apparatus to a vertically long orientation or a horizontally long orientation. In the description below, the same sections as in the first embodiment will not be repeatedly described.

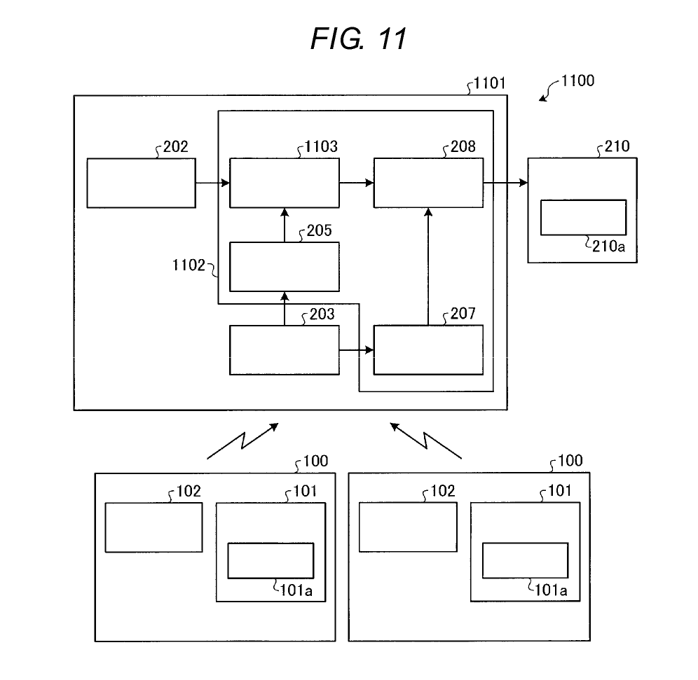

FIG. 11 is a block diagram illustrating the configuration of a display control system according to a third embodiment.

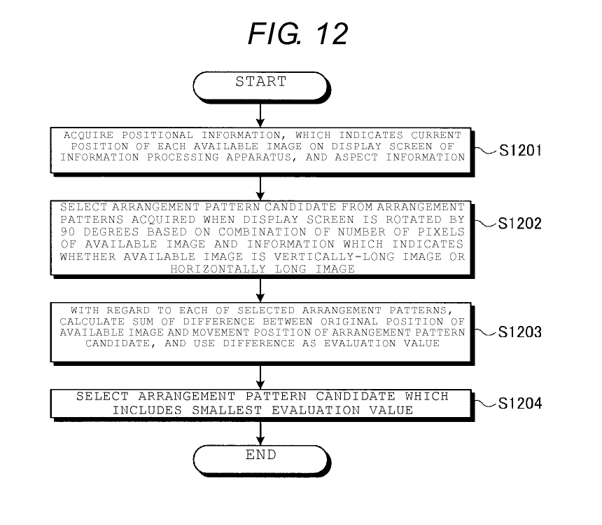

FIG. 12 is a flowchart illustrating the flow of a process to select an arrangement pattern depending on change in the orientation of a display screen in the information processing apparatus according to the third embodiment.

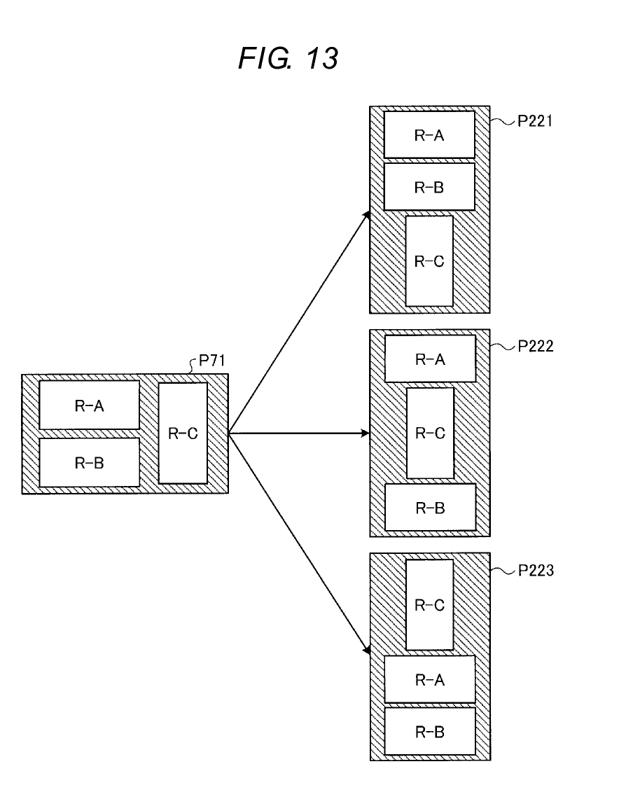

FIG. 13 is a view illustrating the process to select the arrangement pattern depending on the change in the orientation of the display screen in the information processing apparatus according to the third embodiment. A control unit 1101 of an information processing apparatus 1100 according to the embodiment includes the arrangement pattern storage unit 202, the image receiving unit 203, and a display control unit 1102. The display control unit 1102 selects an arrangement pattern when the display screen 210a is changed from to a vertically long orientation to a horizontally long orientation or vice versa.

In this embodiment, if the display screen 210a is rotated by 90 degrees and the orientation thereof is changed to a vertically long orientation or a horizontally long orientation, a display region management unit 1103 acquires positional information which indicates the positions of available images on the display screen 210a, the available images to be displayed on the display screen 210a, and aspect information which indicates the aspect ratios of the available images (step S1201). Further, the display region management unit 1103 determines the number of available images displayed on the display screen 210a based on the acquired positional information. Further, the display region management unit 1103 determines whether the available images displayed on the display screen 210a are vertically long images or horizontally long images based on the acquired aspect information.

Subsequently, the display region management unit 1103 selects arrangement pattern candidates from among the arrangement patterns stored in the arrangement pattern storage unit 202 (that is, the arrangement patterns shown in FIG. 2 or the arrangement patterns shown in FIG. 3) based on the number of images and the information which indicates whether the available images are vertically long images or horizontally long images (step S1202).

Further, with regard to each of the plurality of selected arrangement patterns, the display region management unit 1103 calculates the sum of the movement amount (difference) between the original position of each of the available images displayed on the display screen 210a before 90-degree rotation is performed and a position corresponding to the original position in each of the arrangement pattern candidates on the virtual plane. Further, the display region management unit 1103 uses the calculated sum as the evaluation value of each of the arrangement pattern candidates (step S1203).

Further, the display region management unit 1103 selects an arrangement pattern candidate including the smallest evaluation value (in other words, an arrangement pattern candidate providing the smallest movement amount for the available images displayed on the display screen 210a) as an arrangement pattern among the selected arrangement pattern candidates (step S1204).

For example, as shown in FIG. 13, when available images are displayed on the display screen 210a according to the arrangement pattern P71 which includes two horizontally long-shaped display regions R-A and R-B and a single vertically long-shaped display region R-C and then the display screen 210a is rotated by 90 degrees and the display screen 210a is changed to a vertically long orientation, the display region management unit 1103 selects three arrangement patterns P221 to P223 as the arrangement pattern candidates from the arrangement patterns shown in FIG. 3. Subsequently, the display region management unit 1103 selects the arrangement pattern P222 providing the smallest evaluation value (in other words, the arrangement pattern P222 providing the smallest overall movement amount for the available images displayed on the display screen 210a) among the three arrangement patterns P221 to P223. Therefore, when the display screen 210a is changed to a vertically long orientation or a horizontally long orientation and an arrangement pattern is reselected, it is easy to understand the correspondence between available images acquired before the arrangement pattern is reselected and available images acquired after the arrangement pattern is reselected.

As described above, according to the information processing apparatus 1100 of the third embodiment, when the display screen 210a is changed to a vertically long orientation or a horizontally long orientation, it is not necessary for a user to adjust the display positions of available images, and thus it is possible to improve convenience when the display screen 210a is changed to a vertically long orientation from a horizontally long orientation or changed to a horizontally long orientation from a vertically long orientation.

### Fourth Embodiment

A fourth embodiment is an example which, when the number of images of sharing images acquired after an addition process is greater than the predetermined upper limit number of images, the information processing apparatus “non-displays” the sharing image (that is, does not present/display the sharing image on the display screen 210a).

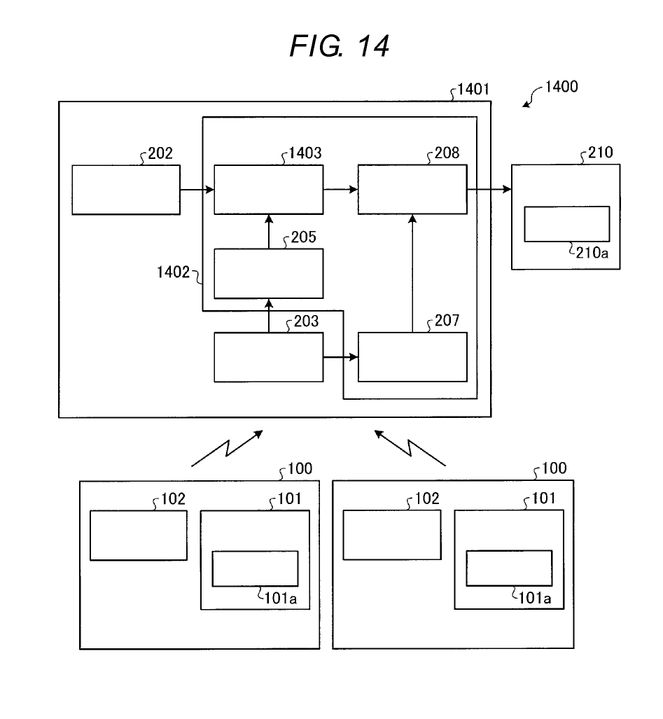

FIG. 14 is a block diagram illustrating the configuration of a display control system according to the fourth embodiment.

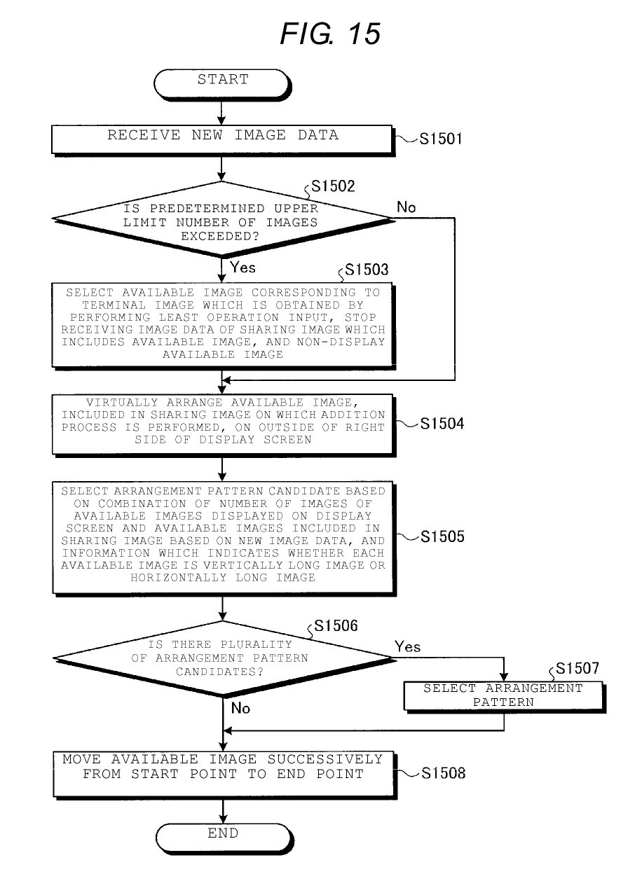

FIG. 15 is a flowchart illustrating the flow of a process to non-display a sharing image.

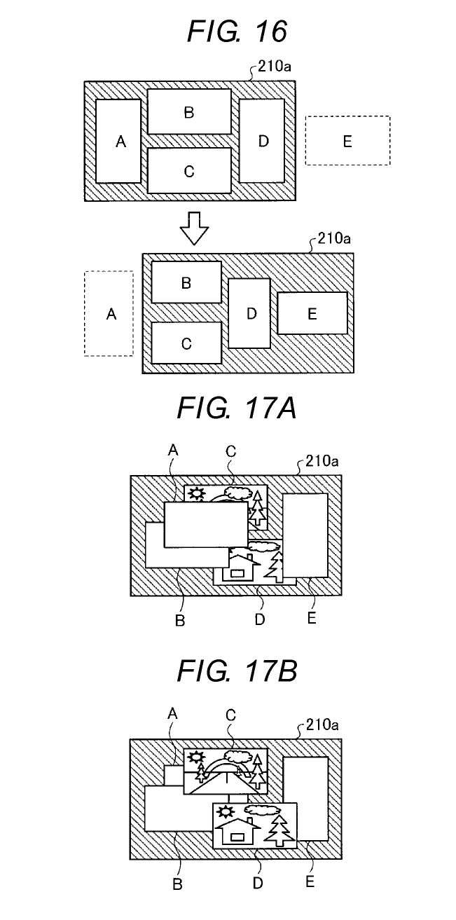

FIG. 16 is a view illustrating the process to non-display the sharing image depending on the addition process in the information processing apparatus according to the fourth embodiment.

A control unit 1401 of an information processing apparatus 1400 includes arrangement pattern storage unit 202, image receiving unit 203, and display control unit 1402.

When the number of sharing images acquired is greater than the predetermined upper limit number of images, the display control unit 1402 non-displays the sharing image which includes an available image(s) corresponding to a terminal image which is obtained by performing less operation input in the mobile terminal apparatus 100 among the plurality of sharing images acquired after the addition process is performed.

In the embodiment, if the image receiving unit 203 receives new image data (step S1501), the display region management unit 1403 determines whether the number of images of the available images to be displayed on the display screen 210a is greater than the predetermined upper limit number of images (in the example embodiment this upper limit number is 4) (step S1502).

Further, when the number of images of the available images to be displayed on the display screen 210a is greater than the predetermined upper limit number of images (Yes in step S1502), the display region management unit 1403 selects an available image corresponding to a terminal image which receives the smallest operation input in the mobile terminal apparatus 100 among the available images displayed on the display screen 210a, and controls the image receiving unit 203 such that the reception of the image data of the sharing image which includes the selected available image is stopped (step S1503). In the embodiment, it is assumed that the display region management unit 1403 first acquires the number of times that operation inputs are performed on the terminal image corresponding to the available image displayed on the display screen 210a from the mobile terminal apparatus 100 which is at the destination of the image data of the sharing image which includes the available images displayed on the display screen 210a.

In addition, the display region management unit 1403 virtually arranges the selected available image on at a position that is outside the display screen 210a on the same virtual plane as the display screen 210a, thereby non-displaying the selected available image (step S1503). Further, the display region management unit 1403 virtually arranges the available images including the sharing image virtually positioned on the outside of the display screen 210a (step S1504).

Subsequently, the display region management unit 1403 selects an arrangement pattern candidate from the arrangement pattern storage unit 202 based on the combination of the number of images of the available images displayed on the display screen 210a and each of the available images included in the sharing image based on the new image data, and information which indicates whether each of the available images displayed on the display screen 210a and each of the available images included in the sharing image based on the new image data are vertically long images or horizontally long images (step S1505).

A method of selecting the arrangement pattern candidate based on the number of available images and information which indicates whether the available images are vertically long images or horizontally long images is similar to the previously described embodiments.

Further, when there are a plurality of selected arrangement pattern candidates (Yes in step S1506), the display region management unit 1403 selects an arrangement pattern based on the evaluation value of each of the plurality of selected arrangement pattern candidates (step S1507). On the other hand, when there is a single selected arrangement pattern candidate (No in step S1506) or when the arrangement pattern is selected based on the evaluation value, the image composition unit 208 successively moves available images displayed on the display screen 210a from a start point S to an end point E in the same manner as in the first embodiment (step S1508).

For example, if new image data is received when available images A to D are displayed on the display screen 210a based on the arrangement pattern P121 (refer to FIG. 2), the display region management unit 1403 arranges an available image (for example, the available image A) corresponding to a terminal image including the smallest operation input in the mobile terminal apparatus 100 on the outside of the left side of the display screen 210a toward the display screen 210a, thereby non-displaying the available image A as shown in FIG. 16. Further, the display region management unit 1403 arranges an available image E, included in the sharing image based on the new image data, on the right side of the display screen 210a, as shown in FIG. 16. Further, the image composition unit 208 displays the available images B to E on the display screen 210a depending on the arrangement pattern (for example, arrangement pattern P112) which is selected in the same manner as in the above-described embodiments, as shown in FIG. 16.

As described above, in the information processing apparatus 1400 according to the fourth embodiment, when the number of images of the sharing images is greater than the predetermined upper limit number of images, it is not necessary for a user to adjust the display positions of the available images, and thus it is possible to improve convenience when the number of images of the sharing images acquired after the addition process is performed is greater than the predetermined upper limit number of images. In addition, it is possible to first display a sharing image which includes high importance on the display screen 210a among a plurality of sharing images acquired after the addition process is performed.

In this embodiment, when the number of images of the sharing images acquired after the addition process is performed is greater than the predetermined upper limit number of images, the display region management unit 1403 stops receiving the image data of the sharing image which includes an available image corresponding to a terminal image which is obtained by performing less operation input in the mobile terminal apparatus 100, and non-displays the sharing image. However, the exemplary embodiment is not limited thereto. For example, when the received image data is moving picture stream data (streaming video), it is possible to configure such that the display region management unit 1403 displays a sharing image on the display screen 210a depending on a scrolling operation (e.g., panning the displayed image of display screen 210a to the left and/or right to display shared images arranged (virtually) outside of an initial displayed image of display screen 210a) performed on the display screen 210a and may non-displays the sharing image now outside the displayed image of display screen 210a, stops receiving the moving picture stream data of the sharing image which is non-displayed, and restarts receiving the moving picture stream data of the sharing image which is newly displayed by the scrolling operation.

### First Modification Example

A first modification example is an information processing apparatus which displays a plurality of sharing images on a display screen with parts of the plurality of sharing images overlapped when the number of sharing images acquired after an addition process is performed is greater than the predetermined upper limit number of images. According to the first modification example, the information processing apparatus also displays a more frequently updated sharing image in front of less frequently updated sharing images. That is, when shared images are arranged to overlap each other, the uppermost image(s) (top of the stacked overlapped images) are the shared images which are updated more frequently by the respective mobile terminal apparatus. In the description below, the same sections as in the fourth embodiment will not be repeatedly described.

FIGS. 17A and 17B are views illustrating a process of displaying a plurality of available images on the display screen by overlapping parts of the plurality of available images depending on the addition process in an information processing apparatus according to the first modification example.

In the modification example, when the number of images of the available images acquired after the addition process is performed is greater than the predetermined upper limit number of images, the image composition unit 208 overlaps parts of the plurality of available images A to E with each other and displays the overlapped available images on the display screen 210a, as shown in FIG. 17A.

When image data which is received by the image receiving unit 203 is moving picture stream data, the image composition unit 208 sequentially displays the available image(s) that is/are updated more frequently by its respective mobile terminal apparatus 200. That is, from among the plurality of available images A to E, as shown in FIG. 17B, the images C and D are updated more frequently and thus are displayed at the top of the overlapped stacks of available images. The update frequency of shared images to be displayed is provided to the image composition unit 208 from each mobile terminal apparatus 100 in advance.

As described above, according to the first modification example, it is possible to acquire the same effect as in the fourth embodiment.

### Second Modification Example

A second modification example is an information processing apparatus which selects a selected sharing image from among a plurality of sharing images and displays the selected image as a full screen image on the display screen 210a. The non-selected sharing images are then displayed in an arrangement pattern that overlaps the selected sharing image displayed on the full screen. In the description below, the same sections as in the above-described embodiments will not be repeatedly described.

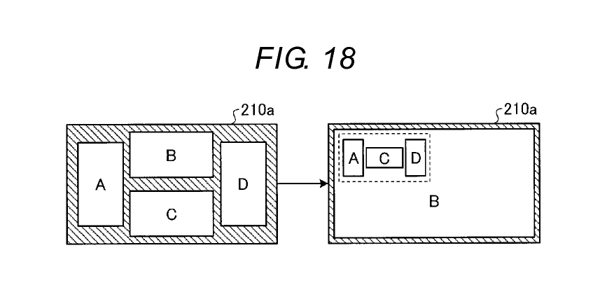

FIG. 18 is a view illustrating a process to display a single available image of a plurality of available images on a full screen in an information processing apparatus according to the second modification example. In the modification example, the image composition unit 208 displays a selected available image (for example, an available image B) on the full screen of display screen 210a, as shown in FIG. 18. The available image may be selected by input of a selection instruction received from an input unit (not specifically depicted).

When the selected available image, is displayed on the full screen, the display region management unit 206 selects an arrangement pattern for the non-selected available images (e.g., A to D) from the arrangement pattern storage unit 202 based on the number of available images less one (to account for the available image displayed on the full screen) and information which indicates whether each of the plurality of non-selected available images is a vertically long image or a horizontally long image. The arrangement pattern selection method for the non-selected images is otherwise the same as in the above-described embodiments.

The image composition unit 208 may overlap a part of the available image displayed on the full screen and display the non-selected available images on the full screen on the display screen 210a according to the selected arrangement pattern, as shown in FIG. 18.

As described above, according to the second modification example, when a selected available image is displayed on the display screen 210a on the full screen, it is still possible to share available images other than the selected available image displayed on the full screen with the mobile terminal apparatus 100.

As described above, according to the first to fourth embodiments, it is possible to improve convenience when available images corresponding to a plurality of terminal images displayed on the plurality of mobile terminal apparatuses are displayed on an information processing apparatus.

A computer program which is executed in the information processing apparatuses 200, 900, 1100, and 1400 according to the embodiments is provided while being embedded in a Read Only Memory (ROM) or other non-transitory storage mediums in advance. In addition, the program which is executed in the information processing apparatuses 200, 900, 1100, and 1400 according to the embodiments may be configured to be provided while being stored in a computer-readable recording medium, such as a CD-ROM, a Floppy Disk (FD), a CD-R, and a Digital Versatile Disc (DVD) in the form of a file which can be installed or which can be executed.

Further, the program which is executed in the information processing apparatuses 200, 900, 1100, and 1400 according to the embodiments may be configured to be stored in a computer which is connected to a network, such as the Internet, and provided through downloading via the network. In addition, the program which is executed in the information processing apparatuses 200, 900, 1100, and 1400 according to the embodiments may be configured to be provided, operated, or distributed via a network, such as the Internet.

The program which is executed in the information processing apparatuses 200, 900, 1100, and 1400 according to the embodiments is configured with modules which include the above-described respective units (the image receiving unit 203, and the display control units 204, 902, 1102, and 1402). The respective units are loaded on a main storage device in such a way that the CPU (processor) may read the program from the ROM as actual hardware and executes the program, and thus the image receiving unit 203 and the display control units 204, 902, 1102, and 1402 may generated in the main storage device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a reception module configured to receive image data from a plurality of external devices, the image data including a plurality of shared images that each correspond to an image displayed on a one of the external devices, respectively; and
a display control module configured to select a first arrangement pattern comprising a plurality of display regions that each correspond to a one of the shared images, respectively, the first arrangement pattern being selected from a plurality of arrangement patterns according to a number of shared images to be displayed on a display screen and information that indicates an aspect ratio of each shared image, and to display the image data on the display screen according to the first arrangement pattern.

2. The information processing apparatus according to claim 1, wherein the display regions are arranged on a virtual plane that includes the display screen, and
the display control module is configured to select a second arrangement pattern from the plurality of arrangement patterns when a shared image is added to or removed from the image data received by the reception module, the second arrangement pattern being selected according to a distance each display region must be moved from respective positions in the first arrangement pattern to corresponding positions in the second arrangement pattern.

3. The information processing apparatus according to claim 2, wherein the second arrangement pattern is selected according to a sum of the distance each display region must be moved from respective positions in the first arrangement pattern to corresponding positions in the second arrangement pattern.

4. The information processing apparatus according to claim 2, wherein the display control module is configured to reduce a displayed size of a shared image from the plurality of shared images that is displayed on the display screen when the shared image is updated by the respective external device at a rate that is below a predetermined threshold rate or is less than other shared images in the image data.

5. The information processing apparatus according to claim 2, wherein the display control module is configured to select a shared image from the plurality of shared images that is not to be displayed on the display screen when a total number of shared images in the image data is greater than a predetermined upper limit.

6. The information processing apparatus according to claim 5, wherein the display control module is configured to select the shared image that is not to be displayed on the display screen according to an update frequency of the shared image.

7. The information processing apparatus according to claim 5, wherein the image data includes streaming video data,
the display control module is configured to perform a scrolling operation on the display screen, and
the reception module is configured to stop receiving streaming video data for any display region that is not displayed on the display screen as a result of the scrolling operation and to start receiving streaming video data for any previously non-displayed display region that is displayed on the display screen as a result of the scrolling operation.

8. The information processing apparatus according to claim 2, wherein the display control module is configured to display the shared images on the display screen by overlapping at least a portion of a first display region from the plurality of display regions with at least a portion of a second display region from the plurality of display regions.

9. The information processing apparatus according to claim 8, wherein the display control module is configured to select the first display region according to an update frequency of the shared image corresponding to the first display region and the update frequency of the shared image corresponding to the first display region is greater than an update frequency of the shared image corresponding to the second display region.

10. The information processing apparatus according to claim 1, wherein the display control module is configured to display only an available portion of each shared image.

11. The information processing apparatus according to claim 1, wherein the display control module is configured to select the first arrangement pattern based on display screen orientation information that indicates whether the display screen has a vertically long orientation or a horizontally long orientation, the number of shared images in the image data, and information for each shared image which indicates whether the shared image is a wide aspect ratio image or a narrow aspect ratio image.

12. The information processing apparatus according to claim 11, wherein the display screen can be changed from vertically long orientation to horizontally long orientation or from horizontally long orientation to vertically long orientation, and
the display control module is configured to select a second arrangement pattern for the plurality of display regions when the orientation of the display screen changes.

13. The information processing apparatus according to claim 1, wherein the display control module is configured to display a selected shared image from the plurality of shared images as a full-screen image on the display screen and to display non-selected shared images from the plurality of shared images so as to overlap the full-screen image, the first arrangement pattern having a number of display regions that is the lesser of a total number of non-selected images or a predetermined upper limit on a total number of display regions in arrangement patterns in the plurality of arrangement patterns.

14. An information processing apparatus, comprising:
a image receiving module configured to receive image data from a plurality of external devices, the image data including a plurality of shared images that each correspond to an image displayed on a one of the external devices, respectively;
a display control module configure to select an arrangement pattern comprising a plurality of display regions that each correspond to a one of the shared images, respectively; and
an arrangement pattern storage module configured to store predetermined arrangement patterns having a number of display regions up to a predetermined upper limit of display regions, wherein
the arrangement pattern is selected from the arrangement pattern storage module by the display control module according to a number of shared images in the image data and information that indicates an aspect ratio of each shared image.

15. The information processing apparatus of claim 14, further comprising:
an image analysis module configured to provide information that indicates the aspect ratio of each shared image.

16. The information processing apparatus of claim 14, further comprising:
a display screen on which the plurality of shared images is displayed in the arrangement pattern.

17. A display control method, comprising:
receiving image data from a plurality of external devices, the image data including a plurality of shared images that each correspond to an image displayed on a one of the external devices, respectively;
selecting a first arrangement pattern comprising a plurality of display regions that each correspond to a one of the shared images, respectively, the first arrangement pattern being selected from a plurality of arrangement patterns according to a number of shared images to be displayed on a display screen and information that indicates an aspect ratio of each shared image; and
displaying the image data on the display screen according to the first arrangement pattern.

18. The display control method according to claim 17, further comprising:
selecting a second arrangement pattern from the plurality of arrangement patterns when a shared image is added to or removed from the image data that is received, the second arrangement pattern being selected according to a distance each display region must be moved from respective positions in the first arrangement pattern to corresponding positions in the second arrangement pattern.

19. The display control method of claim 17, further comprising:
selecting a shared image from the plurality of shared images that is not to be displayed on the display screen when a total number of shared images in the image data is greater than a predetermined upper limit;
positioning the selected shared image that is not to be displayed on the display in a virtual position outside of the display screen; and
performing a scrolling operation on the display screen to display the virtual position.

20. The display control method of claim 17, further comprising:
a selecting a second arrangement pattern from the plurality of arrangement patterns when an orientation of the display screen is changed, the second arrangement pattern being selected according to a distance each display region must be moved from respective positions in the first arrangement pattern to corresponding positions in the second arrangement pattern.
